(19) United States
(12) Patent Application Publication
(10) Pub. No.: US 2026/0067613 A1
(43) Pub. Date: Mar. 5, 2026

(54) SOUND REPRODUCING DEVICE, ACOUSTIC SYSTEM, AND MOBILE DEVICE

(71) Applicant: SONY GROUP CORPORATION, TOKYO (JP)

(72) Inventor: TAKEHIKO TANAKA, TOKYO (JP)

(21) Appl. No.: 19/106,205

(22) PCT Filed: Jul. 10, 2023
(86) PCT No.: PCT/JP2023/025500

§ 371 Date: Feb. 24, 2025

(30) Foreign Application Priority Data
Sep. 1, 2022 (JP) 2022-139093

(51) Int. Cl. H04R 1/32; H04R 5/02; H04S 3/00

(52) U.S. Cl. CPC H04R 1/323; H04R 5/023; H04S 3/008; H04R 2201/405; H04R 2205/024; H04R 2499/13; H04S 2400/01; H04S 2400/05

(57) ABSTRACT

For example, a sound reproducing device that is installed in a vehicle interior and realizes directional control is provided. The sound reproducing device includes a speaker, and a sound-absorbing part arranged in front of the speaker and configured to control an emission angle of a sound emitted from the speaker. The sound-absorbing part includes a sound-absorbing material and absorbs a sound emitted from the speaker in an unnecessary direction. The sound reproducing device further includes a reflecting part includes a reflecting plate with a glass-shape, reflects a sound after passing through the sound-absorbing part and direct the sound in a desired direction, and the sound reproducing device forms a sound field that allows the sound from the speaker to be perceived as a sound coming from a virtual speaker arranged outside the reflecting plate.

### TECHNICAL FIELD

The technology disclosed in the present specification (hereinafter, “the present disclosure”) relates to a sound reproducing device, an acoustic system, and a mobile device, which are installed, for example, in a vehicle interior and implement directional control.

### BACKGROUND ART

A speaker system used in a vehicle interior generally has a configuration in which left and right speakers are installed at left and right ends of an upper surface of a dashboard or the like to form forward localization for a listener (occupant). For example, a vehicle speaker system has been proposed in which a first speaker used for the ultra-low frequency range and the low frequency range, and left and right second speakers used for the mid- and high-frequency ranges are installed in the front section of the vehicle interior to enhance sense of the forward localization (see Patent Document 1).

However, in the speaker system in which the speakers are arranged on the left and right in front of the vehicle interior, a sound field is formed in the vicinity of the center of the vehicle interior (for example, between the driver's seat and the passenger's seat), and the sound field does not exist in front of any occupant sitting on the driver's seat and the passenger's seat. Furthermore, in the speaker system in which a center speaker is arranged between the left and right speakers, the center speaker can output an L+R signal in which an L signal for the driver's seat and an R signal for the passenger's seat are superimposed to form a sound field in front of each of the driver's seat and the passenger's seat. However, there is a problem that the sound field is unstable, for example, due to variations in localization depending on a music to be reproduced because a signal that cancels the L signal and the R signal exists.

Furthermore, in other words, there is also a problem that a sound image is localized at a position lower than the face of a listener sitting on the driver's seat or the passenger's seat by the sound directly delivered from the speaker arranged on the upper surface of the dashboard.

### CITATION LIST

### Patent Document

Patent Document 1: Japanese Patent Application Laid-Open No. 2019-166947
Patent Document 2: Japanese Patent Application Laid-Open No. 2003-111200
Patent Document 3: U.S. Pat. No. 9,749,769

### SUMMARY OF THE INVENTION

### Problems to be Solved by the Invention

An object of the present disclosure is to provide a sound reproducing device, an acoustic system, and a mobile device that implements a directional control and accurately localize sound images in front of occupants in a vehicle interior, respectively.

### Solutions to Problems

The present disclosure has been made in consideration of the above-described problems, and a first aspect thereof is a sound reproducing device, the sound reproducing device including:
a speaker; and
a sound-absorbing part arranged in front of the speaker and configured to control an emission angle of a sound emitted from the speaker.

The sound-absorbing part includes a sound-absorbing material and absorbs a sound emitted from the speaker in an unnecessary direction.

The sound reproducing device according to the first aspect further includes a reflecting part configured to reflect a sound after passing through the sound-absorbing part to direct the sound in a desired direction. The reflecting part includes a reflecting plate with a glass-shape. Furthermore, the sound reproducing device then forms a sound field that allows the sound from the speaker to be perceived as a sound coming from a virtual speaker arranged outside the reflecting plate.

Furthermore, a second aspect of the present disclosure is an acoustic system, the acoustic system including:
a plurality of sound reproducing units provided for each seat in an interior of a mobile device, in which
each sound reproducing unit includes a speaker and a sound-absorbing part that is arranged in front of the speaker and absorbs an emission sound in an unnecessary direction.

However, the term “system” referred to here indicates a logical assembly of multiple devices (or functional modules that implement specific functions), and it does not matter whether or not each of the devices or functional modules is in a single housing. That is, one device including multiple components or functional modules and an assembly of multiple devices correspond to the “system”.

Furthermore, a third aspect of the present disclosure is a mobile device, the mobile device including:
a plurality of sound reproducing units provided for each seat in an interior, in which
each sound reproducing unit includes a speaker and a sound-absorbing part that is arranged in front of the speaker and absorbs an emission sound in an unnecessary direction.

### Effects of the Invention

According to the present disclosure, it is possible to provide a sound reproducing device, an acoustic system, and a mobile device that implements a directional control and accurately localize sound images in front of occupants in a vehicle interior, respectively.

Note that, effects described in the present specification are merely examples, and the effects brought about by the present disclosure are not limited thereto. Furthermore, the present disclosure may further provide additional effects in addition to the effects described above.

Still other objects, features, and advantages of the present disclosure will become apparent from a more detailed description based on embodiments as described later and the accompanying drawings.

### BRIEF DESCRIPTION OF DRAWINGS

FIG. 1 is a diagram illustrating a configuration of a vehicle speaker system 100.

FIG. 2 is a diagram illustrating a configuration of a speaker 111L.

FIG. 3 is a diagram illustrating a mechanism in which virtual speakers are arranged using the directional control and the reflection of a windshield.

FIG. 4 is a diagram illustrating the lateral inclination of an emission direction of an emission sound from each of speakers 111 L and 111R, and speakers 121 L and 121R.

FIG. 5 is a diagram illustrating the simulation results of an emission sound, a reflection sound, and a sound field of a speaker in the vehicle speaker system 100.

FIG. 6 is a diagram illustrating the simulation results of the emission sound, the reflection sound, and the sound field of the speaker in the vehicle speaker system 100.

FIG. 7 is a diagram illustrating the simulation results of the emission sound, the reflection sound, and the sound field of the speaker in the vehicle speaker system 100.

FIG. 8 is a diagram illustrating the simulation results of the emission sound, the reflection sound, and the sound field of the speaker in the vehicle speaker system 100.

FIG. 9 is a diagram illustrating the simulation results of the emission sound, the reflection sound, and the sound field of the speaker in the vehicle speaker system 100.

FIG. 10 is a diagram illustrating a configuration example of a vehicle interior in which an in-vehicle three-dimensional acoustic system 1000 is mounted.

FIG. 11 is a diagram illustrating a configuration example of a vehicle interior in which an in-vehicle three-dimensional acoustic system 1100 is mounted.

FIG. 12 is a diagram illustrating an arrangement example of assist speakers (an example in which the assist speakers are incorporated in a dashboard).

FIG. 13 is a diagram illustrating an arrangement example of an assist speaker (an example in which a high-frequency range assist speaker is incorporated in a front pillar).

FIG. 14 is a diagram illustrating an arrangement example of an assist speaker (an example in which a mid-frequency range assist speaker is incorporated in a front door).

FIG. 15 is a diagram illustrating an arrangement example of a rear speaker (an example in which a high-frequency range assist speaker and a mid-frequency range assist speaker both are incorporated in a rear door).

FIG. 16 is a diagram illustrating an arrangement example of a surround speaker (an example in which a surround speaker is incorporated in a rear pillar).

FIG. 17 is a diagram illustrating a state in which a target sound field is generated using a plurality of sound reproducing devices in a vehicle interior.

FIG. 18 is a diagram illustrating a state in which a target sound field is generated using the plurality of sound reproducing devices in the vehicle interior.

FIG. 19 is a diagram illustrating a configuration example of a speaker system in which speakers are arranged at three positions on the left, right, and center of a dashboard.

### MODE FOR CARRYING OUT THE INVENTION

Hereinafter, the present disclosure will be described in the following order with reference to the drawings.
A. First Example
   A-1. Basic Configuration
   A-2. Prevention of Mixing between Adjacent Sound Fields
   A-3. Detailed Study In Consideration of Windshield Shape
B. Second Example
   B-1. First Type
   B-2. Second Type
   B-3. Method of Incorporating Assist Speaker
C. Practical Example
   C-1. Application to Monopole
   C-2. Application to Sound Zoning
   C-3. Application to Noise Canceling

### A. First Example

### A-1. Basic Configuration

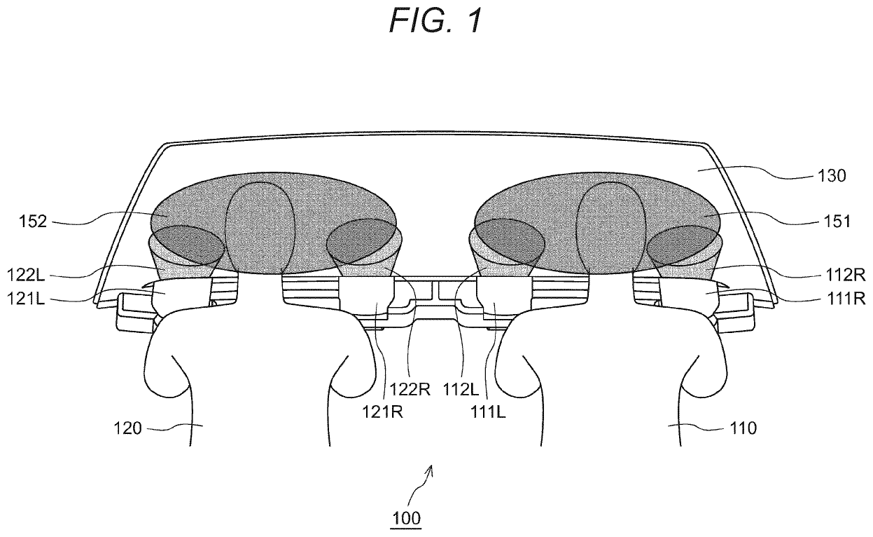

FIG. 1 illustrates a configuration of a vehicle speaker system 100 to which a directional control speaker according to a first example of the present disclosure is applied. However, FIG. 1 illustrates a state in which the front of the vehicle interior of the vehicle in which the vehicle speaker system 100 is mounted is viewed from the rear of the vehicle interior.

The vehicle speaker system 100 includes left and right speakers 111L and 111R installed in front of an occupant (driver) 110 seated in the driver's seat (not illustrated), and left and right speakers 121L and 121R installed in front of an occupant (passenger) 120 seated in the passenger's seat (not illustrated). All of the speakers 111L and 111R and 121L and 121R are incorporated in, for example, the upper surface of a dashboard (not illustrated). Note that, the speakers 111R and 121L at the left and right ends may be incorporated in the left and right doors or pillars, respectively.

It is assumed that the directivities of the left and right speakers 111L and 111R are highly controlled. In FIG. 1, the directivities of emission sounds from the speakers 111L and 111R are denoted by reference numerals 112L and 112R, respectively. Then, the emission sound from each of the speakers 111L and 111R is reflected by a windshield (front windshield) 130, followed by reaching the vicinity of the face of the occupant 110 seated in the driver's seat. The occupant 110 can perceive the respective reflection sounds of the left and right speakers 111L and 111R as sounds that respectively come from the positions of left and right virtual speakers arranged outside the windshield 130. As a result, an individual sound field 151 for the occupant 110 is formed in front of the occupant 110.

Similarly, it is assumed that the directivities of the left and right speakers 121L and 121R are highly controlled. In FIG. 1, the directivities of emission sounds from the speakers 121L and 121R are denoted by reference numerals 122L and 122R, respectively. Then, the emission sound from each of the speakers 121L and 121R is reflected by the windshield (front windshield) 130, followed by reaching the vicinity of the face of the occupant 120 seated in the passenger's seat. The occupant 120 can perceive the respective reflection sounds of the left and right speakers 121L and 121R as sounds that respectively come from the positions of left and right virtual speakers arranged outside the windshield 130. As a result, an individual sound field 152 for the occupant 120 is formed in front of the occupant 120.

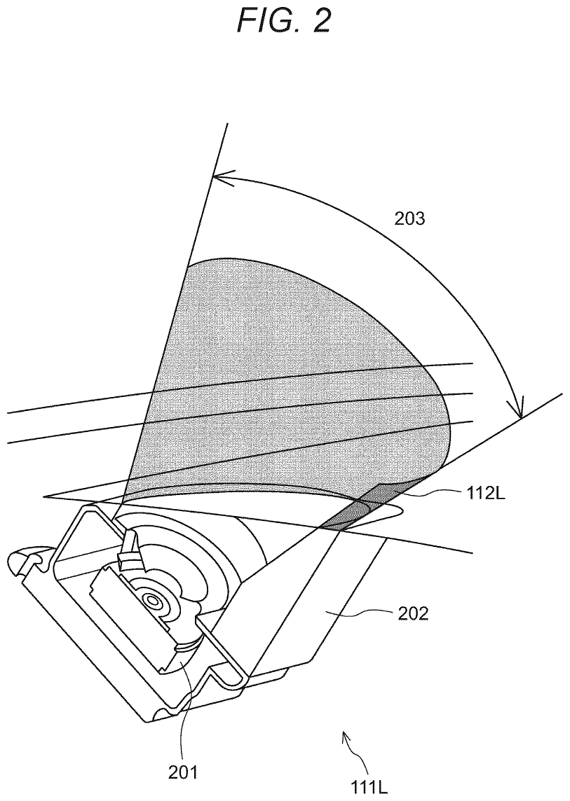

As described above, it is assumed that the directivities of each of the speakers 111L and 111R, and 121L and 121R are highly controlled. FIG. 2 representatively illustrates a configuration of the speaker 111L. The speaker 111L includes a speaker main body 201 and a sound-absorbing material 202. The speaker main body 201 is a general speaker unit including, for example, a diaphragm, a coil, and a magnet. Furthermore, the sound-absorbing material 202 includes, for example, a porous material such as urethane, or a material such as glass wool, rock wool, or felt, and absorbs air vibration incident on the surface. In the present example, the sound-absorbing material 202 is configured to absorb a wavefront traveling forward without reaching the windshield 130 in the air vibration emitted from the speaker main body 201 to control an emission angle 203 from the speaker main body 201.

Note that, although not illustrated, the other speakers 111R, 121 L, and 121R have the similar configuration.

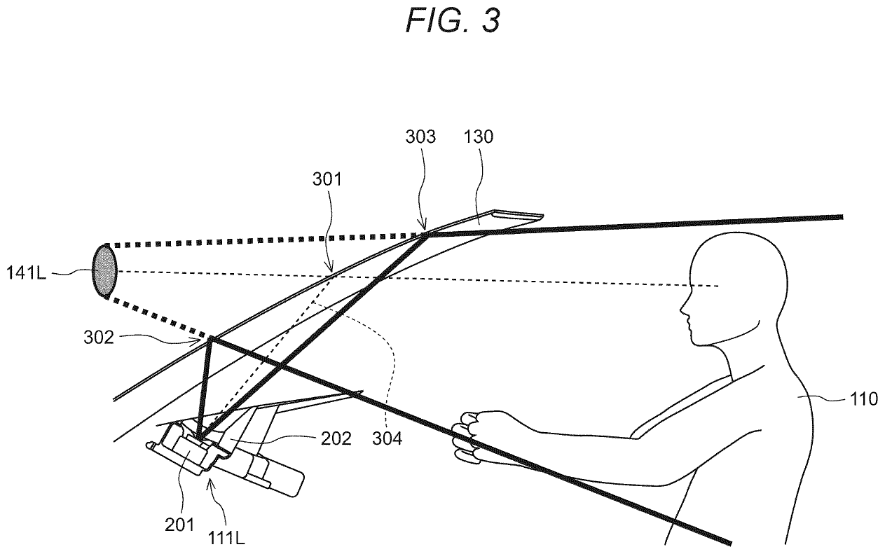

Subsequently, FIG. 3 illustrates a mechanism in which a virtual speaker 141L corresponding to the real speaker 111L is arranged upon the combination of the directional control using the sound-absorbing material 202 and the reflection on the windshield 130 on a cross section of the vehicle interior cut along a plane perpendicular to the traveling direction and the vertical direction of the vehicle.

As described with reference to FIG. 1, the emission sound from the speaker 111L is reflected by the windshield 130 and reaches the vicinity of the face of the occupant 110. In that case, the occupant 110 perceives the reflection sound of the speaker 111L as an emission sound from the position of the virtual speaker 141L. That is, the virtual speaker 141L corresponding to the real speaker 111L is arranged outside the windshield 130. The occupant 110 can listen to the sound of the virtual speaker 141L positioned farther than the real speaker 111L in good condition (that is, a sound field with depth is realized). Furthermore, since the virtual speaker 141L is positioned on the opposite side to a reflection point 301 of the windshield 130, a sound image can be made at a position higher than the position where the real speaker 111L is mounted.

Here, the virtual speaker 141L is arranged at a position substantially level with the eyes of the occupant 110. Therefore, the intersection between the line segment connecting the virtual speaker 141L and the eyes of the occupant 110, and the windshield 130 is the reflection point 301 of the emission sound of the real speaker 111L (the center axis of the diaphragm). In such a case, an emission direction is adjusted such that the center axis (alternatively, the center of the emission sound of the speaker 111L) 304 of the diaphragm constituting the speaker main body 201 of the speaker 111L intersects the reflection point 301 on the windshield 130, and the speaker 111L is incorporated in the upper surface of the dashboard. Furthermore, a range of the emission angle of the virtual speaker 141L is limited from the top of the head to the upper abdomen of the occupant 110 so that the sound field does not unnecessarily spread. In FIG. 3, an intersection point at which the upper end of the emission angle of the virtual speaker 141L intersects the windshield 130 and an intersection point at which the lower end of the emission angle of the virtual speaker 141L intersects the windshield 130 are indicated by reference numerals 302 and 303, respectively. Therefore, the directivity of the speaker 111L is controlled using the sound-absorbing material 202 so that the emission angle (203) of the real speaker 111L does not spread beyond the intersections 302 and 303.

Assuming the average physique of the occupant 110, it is only required that the position, emission direction, and emission angle of the real speaker 111L are determined on the basis of the calculation result of the reflected wave as illustrated in FIG. 3, followed by incorporation into the upper surface of the dashboard or the like. As a modification, the speaker 111L may be movably attached to the dashboard or the like so that the position and the emission direction of the real speaker 111L can be adjusted. In this case, processes of measuring the actual position of the head section of the occupant 110 using an in-vehicle monitor camera or the like and calculating the reflected wave may be sequentially performed to adjust the position and the emission direction of the speaker 111L so that individual differences are optimized. Moreover, the sound-absorbing material 202 may be movable so that the magnitude of the emission angle of the speaker 111L can be adjusted. For example, the position and the emission direction of the speaker 111L may be adjusted such that the emission angle suitable for the individual differences of the occupant 110, the traveling situation and surrounding environment of the vehicle, the attributes of the music content to be reproduced, and the like is estimated using a machine learning model, and the sound field 151 with an optimum location and a size can be formed.

Note that, although not illustrated, the corresponding virtual speakers 141R, 142L, and 142R (all not illustrated) with the mechanism similar to that in FIG. 3 are arranged for the other speakers 111R, 121L, and 121R. Furthermore, the other speakers 111R, 121L, and 121R may also be movably attached.

To briefly summarize the explanation so far, the vehicle speaker system 100 according to the present example can generate a sound field independently for each occupant with depth and aligned at face height of the occupant by combining the directional control of the left and right speakers installed for each occupant and the reflection on the windshield.

### A-2. Prevention of Mixing Between Adjacent Sound Fields

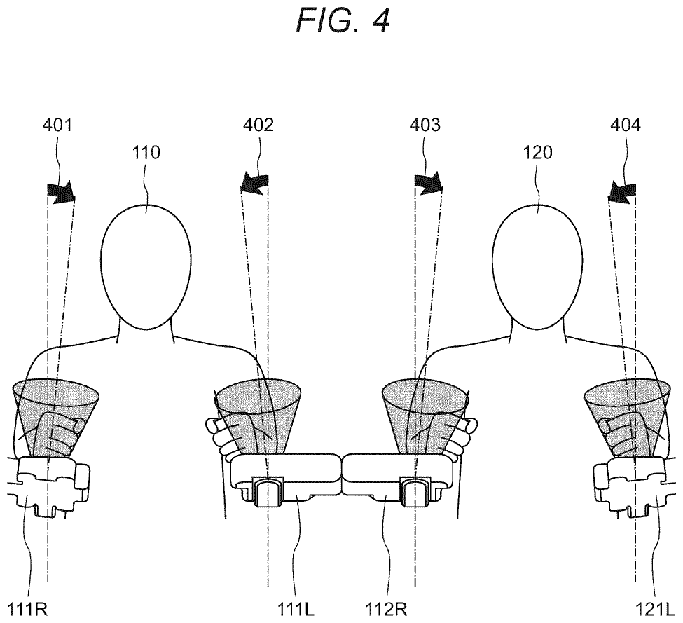

FIG. 3 illustrates the vertical inclination of the emission direction of the emission sound from the speaker 111L in an easily understandable manner, but it is difficult to understand the horizontal inclination or the lateral inclination. Thus, the lateral inclination of an emission direction of an emission sound from each of speakers 111L and 111R, and speakers 121L and 121R will be described using FIG. 4. FIG. 4 illustrates a state in which the speakers 111L and 111R for the occupant 110 in the driver's seat and the speakers 121L and 121R for the occupant 120 in the passenger's seat are viewed from the front of the vehicle (through the windshield 130).

In order to maintain high quality of sound to be listened to by the occupant 110 and the occupant 120, it is necessary to reduce sound mixing in a high-frequency range between the sound field 151 and the sound field 151 respectively formed for the occupants. Therefore, as indicated by arrows 401 to 404 in FIG. 4, the respective emission directions of the speakers 111L and 111R for the occupant 110 in the driver's seat are not directed directly rearward, but are inclined toward the driver's seat (or the occupant 110).

Similarly, the respective emission directions of the speakers 121L and 121R for the occupant 120 in the passenger's seat are not directed directly rearward, but are inclined toward the passenger's seat (or the occupant 120). Since the speaker 111R and the speaker 121 L adjacent to each other at the center are inclined toward the driver's seat and the passenger's seat respectively, it is possible to prevent emission sound mixing to each other.

Moreover, the emission sound in an unnecessary direction is absorbed by the sound-absorbing material attached to an emission port of the speaker main body, so that it can be designed to make it difficult to hear the adjacent sound in the high-frequency range. Furthermore, a movable sound-absorbing material may be attached as necessary so that the magnitude of the emission angle of the speaker can be adjusted (the same as above).

In summary, it is necessary to consider the arrangement positions, the emission direction, and the shape of the sound-absorbing material of the speaker 111R and the speaker 121L arranged at the center of the dashboard so that the ideal sound fields 151 and 152 can be reproduced in front of the driver and passenger on the left and right respectively.

In the above description, it has been described as the configuration of the vehicle speaker system 100 in which the left and right speakers 111L and 111R are provided in the driver's seat and the left and right speakers 121L and 121R are provided in the passenger's seat, and the sound fields 151 and 152 for the respective occupants are generated using a total of four speakers. As an alternative, a system configuration is also conceivable in which the left speaker 111L for the driver's seat and the right speaker 121R for the passenger's seat, which are adjacent in the vicinity of the center of the dashboard, are integrated into one, and a total of three speakers including a right speaker 1901, a center speaker 1902, and a left speaker 1903 are used on the dashboard to generate sound fields 1904 and 1905 for the occupants respectively as illustrated in FIG. 19.

In the vehicle speaker system illustrated in FIG. 19, the right speaker 1901 outputs a sound on the right side of the driver, and the center speaker 1902 outputs a sound on the left side of the driver to generate a sound field 1904 for the driver. Similarly, the center speaker 1902 outputs a sound on the right side of the passenger, and the left speaker 1903 outputs a sound on the left side of the passenger to generate a sound field 1905 for the passenger. However, there is a problem that the sound fields 1904 and 1905 are not stable, such as localization variation, depending on a reproduction sound (music or the like) because signals that cancel each other are included when both the sound on the left side of the driver and the sound on the right side of the passenger are output from the center speaker 1902. Therefore, in order to deliver high quality sound to each occupant, it is preferable to arrange left and right speakers for each seat.

### A-3. Detailed Study In Consideration of Windshield Shape

The vehicle speaker system 100 according to the present example combines the directional control and the reflection of the windshield to form an optimum sound field independently for each seat (that is, for each occupant). For this purpose, the position, angle and emission range of each speaker are designed on the basis of reflected wave calculations so that the emission sounds from the left and right speakers installed in each seat are reflected by the three-dimensional curved surface of the windshield and directed toward the corresponding occupants, and the shapes of the sound-absorbing material are determined to realize the desired directivities of the emission sounds, followed by installation in the vehicle interior

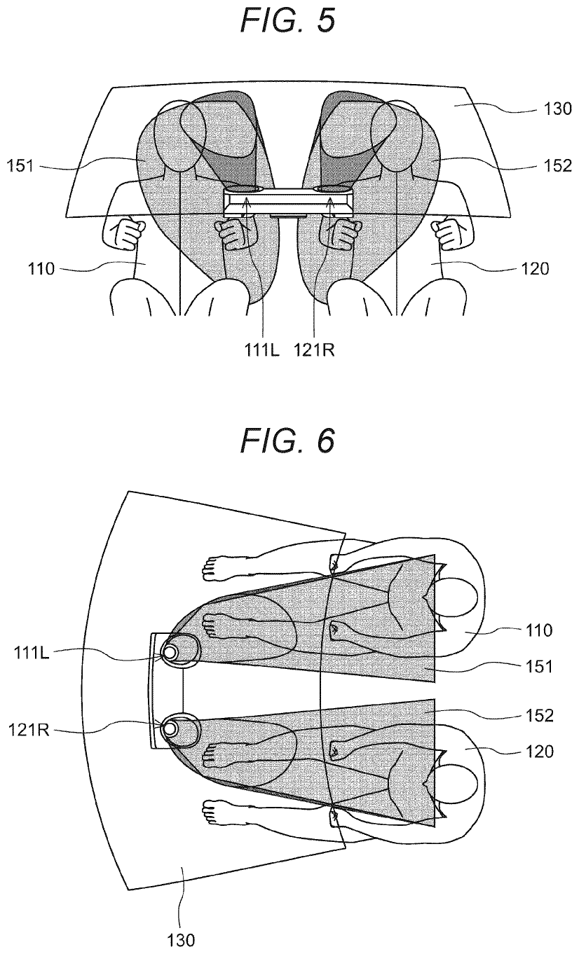

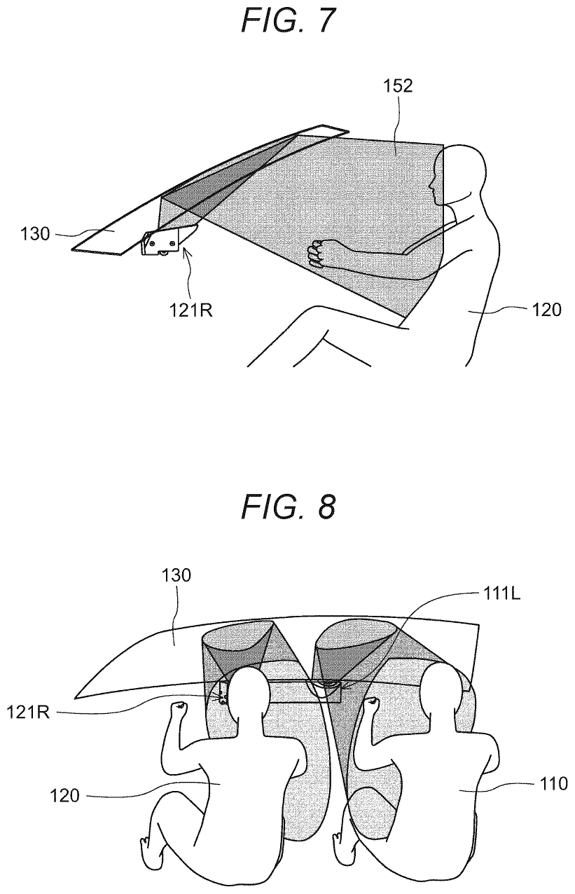

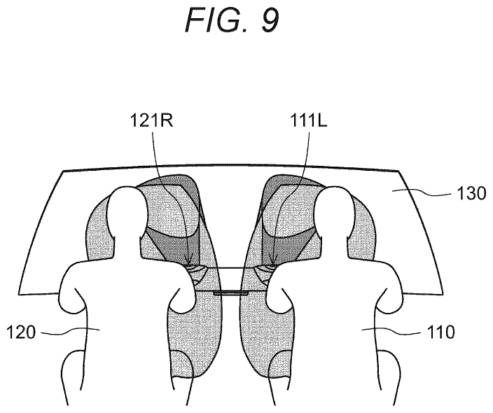

FIGS. 5 to 9 illustrate simulation results in which the sound fields 151 and 152 individually formed for the occupant 110 and the occupant 120, respectively, and respective emission sounds, reflection sounds, and sound fields of the left speaker 111L installed for the occupant 110 and the right speaker 121R installed for the occupant 120 are drawn in a three-dimensional space. However, FIG. 5 is a view as viewed from the front of the vehicle, FIG. 6 is a view as viewed from above the vehicle interior, FIG. 7 is a view illustrating an emission sound and a reflection sound from the right speaker 121R involved in one horizontal component of a sound field for the occupant 120, FIG. 8 is a perspective view from the rear left of the vehicle interior, and FIG. 9 is a view as viewed from the rear of the vehicle interior toward the front (in a direction opposite to FIG. 5).

### B. Second Example

For example, there has been proposed an acoustic system in which left and right stereo speakers are incorporated in left and right sides of a shoulder section or a headrest of a backrest portion of a seat (hereinafter, collectively referred to as the “headrest”) for each seat in a vehicle interior to individually provide a virtual sound field having a sufficient surround feeling for each occupant sitting in each seat (see Patent Document 2). For example, in order to realize sense of the sound image localization in the reproduction sound by headphones, it is necessary to obtain the head-related transfer function (HRTF) of a sound transmission path from a sound source position to the entrance to the ear canal of the listener's ear and convolve the obtained head-related transfer function into a signal of the reproduction sound. On the other hand, in a case of an acoustic system using a seat speaker incorporated in a headrest of a seat, it is possible to generate a sound field around the entire circumference centered on the head section of the occupant sitting on the seat without measuring the HRTF.

On the other hand, the vehicle speaker system described as the first example in Section A described above is a forward localization system using reflection of the emission sound from the speaker arranged on the dashboard by the windshield. In this Section B, an example in which the directional control speaker according to the present disclosure is applied as an assist speaker to an acoustic system using a seat speaker will be described as a second example of the present disclosure.

### B-1. First Type

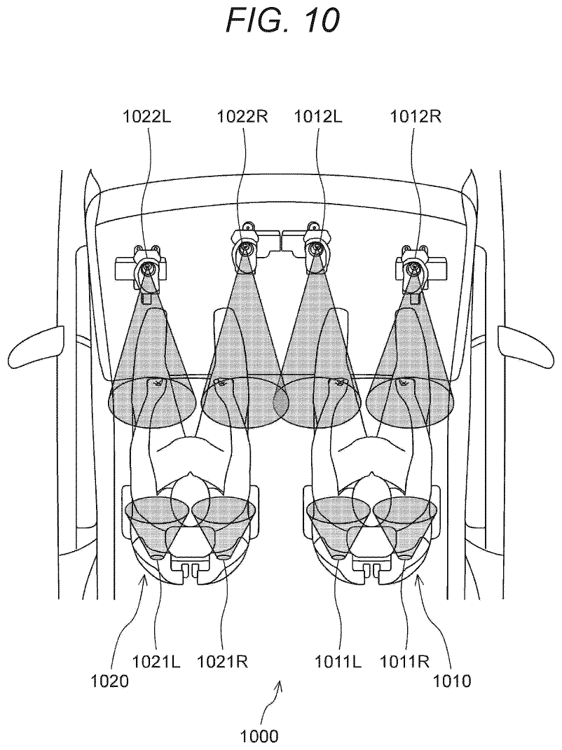

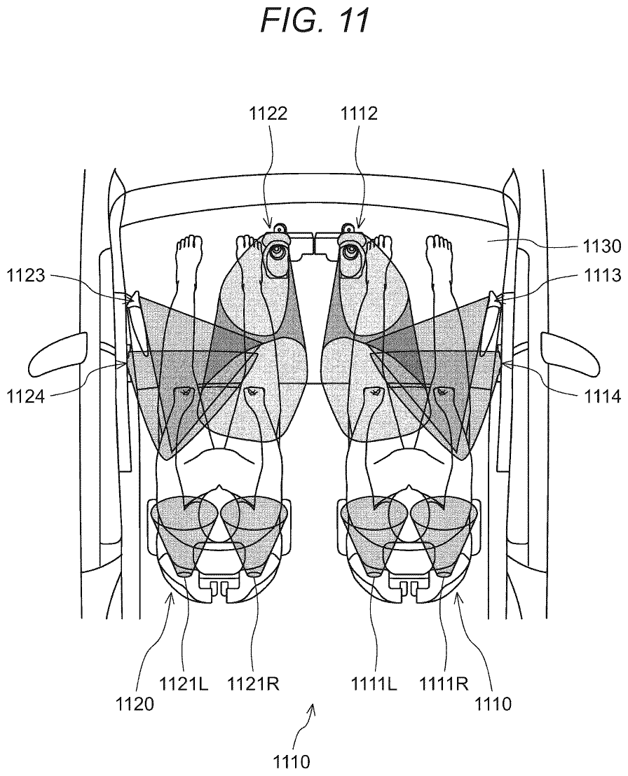

FIG. 10 illustrates a configuration example of the vehicle interior in which an in-vehicle three-dimensional acoustic system 1000 using the directional control speaker according to the present disclosure as an assist speaker. Note that, for convenience, only the front half of the vehicle interior including the front row seats including the driver's seat and the passenger's seat is illustrated.

A left seat speaker 1011L and a right seat speaker 1011R, which are main speakers, are incorporated on the left and right of the headrest at the upper end of the backrest of a driver's seat 1010, respectively. Both the left seat speaker 1011L and the right seat speaker 1011R are arranged such that the emission directions are directed toward the front of the vehicle. The emission sounds from the left seat speaker 1011L and the right seat speaker 1011R directly reach the left and right ears of the driver sitting in the driver's seat 1010, respectively, and provide the driver with a three-dimensional virtual sound field.

Similarly, a left seat speaker 1021L and a right seat speaker 1021R, which are main speakers, are incorporated on the left and right of the headrest at the upper end of the backrest of a passenger's seat 1020, respectively. Both the left seat speaker 1021L and the right seat speaker 1021R are arranged such that the emission directions are directed toward the front of the vehicle. The emission sounds from the left seat speaker 1021L and the right seat speaker 1021R directly reach the left and right ears of the passenger sitting in the passenger's seat 1020, respectively, and provide the occupant with a three-dimensional virtual sound field.

On the other hand, a left assist speaker 1012L and a right assist speaker 1012R, which respectively assist the seat speakers, are incorporated on the upper surface of the dashboard in the vicinity of the front of the driver's seat 1011. It is assumed that both the left assist speaker 1012L and the right assist speaker 1012R output acoustic components encompassing the full-frequency range from the low-frequency range to the high-frequency range. As described in Section A described above, the directivities of the left assist speaker 1012L and the right assist speaker 1012R are highly controlled by the combination with the sound-absorbing material.

The emission sounds from the left assist speaker 1012L and the right assist speaker 1012R directly reach the vicinity of the face of the driver sitting in the driver's seat 1010. The sound field (not illustrated) is formed by the left assist speaker 1012L and the right assist speaker 1012R enables interpolation of a three-dimensional audio space in which the emission sounds from the left seat speaker 1011L and the right seat speaker 1011R are generated, and the sense of localization is thus improved.

Similarly, a left assist speaker 1022L and a right assist speaker 1022R, which respectively assist the seat speakers, are incorporated on the upper surface of the dashboard in the vicinity of the front of the passenger's seat 1021. It is assumed that both the left assist speaker 1022L and the right assist speaker 1022R output acoustic components encompassing the full-frequency range from the low-frequency range to the high-frequency range. As described in Section A described above, the directivities of the left assist speaker 1022L and the right assist speaker 1022R are highly controlled by the combination with the sound-absorbing material.

The emission sounds from the left assist speaker 1022L and the right assist speaker 1022R directly reach the vicinity of the face of the occupant sitting in the passenger's seat 1020. The sound field (not illustrated) formed by the left assist speaker 1022L and the right assist speaker 1022R enables interpolation of a three-dimensional audio space generated by the emission sounds from the left seat speaker 1021L and the right seat speaker 1021R.

### B-2. Second Type

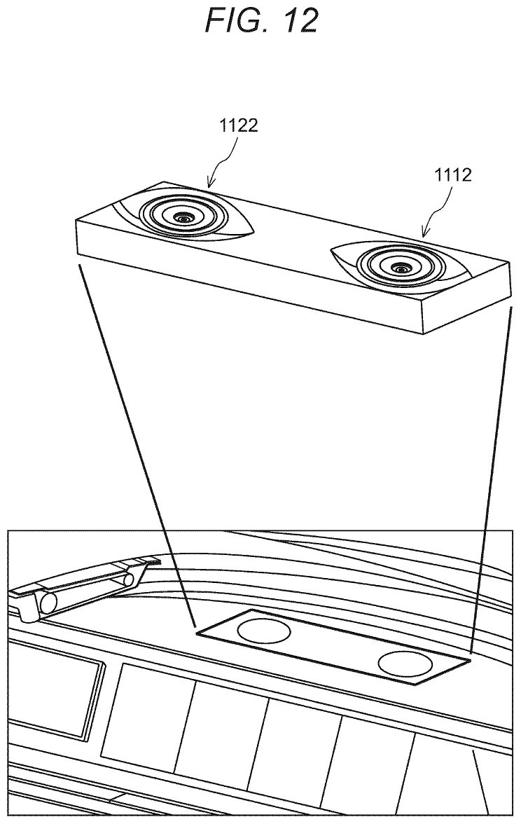

FIG. 11 illustrates a configuration example of the vehicle interior in which another in-vehicle three-dimensional acoustic system 1100 using the directional control speaker according to the present disclosure as an assist speaker. Note that, for convenience, only the front half of the vehicle interior including the front row seats including the driver's seat and the passenger's seat is illustrated.

A left seat speaker 111L and a right seat speaker 111R, which are main speakers, are arranged on the left and right of the headrest at the upper end of the backrest of a driver's seat 1110, respectively, such that the emission directions are directed toward the front of the vehicle. The emission sounds from the left seat speaker 111L and the right seat speaker 111R respectively provide the driver sitting in the driver's seat 1110 with a three-dimensional virtual sound field. Similarly, a left seat speaker 1121L and a right seat speaker 1121R, which are main speakers, are arranged on the left and right of the headrest at the upper end of the backrest of a passenger's seat 1120, respectively, such that the emission directions are directed toward the front of the vehicle. The emission sounds from the left seat speaker 1121L and the right seat speaker 1121R respectively provide the occupant sitting in the passenger's seat 1120 with a three-dimensional virtual sound field.

On the other hand, as the assist speaker for the driver sitting in the driver's seat 1110, a full-frequency range assist speaker 1112 incorporated on the upper surface of the dashboard in the vicinity of the front of the driver's seat 1110, and a high-frequency range assist speaker 1113 and a mid-frequency range assist speaker 1114, which are incorporated in the inner wall (alternatively, the front pillar) of the door on the driver's seat side are arranged. The directivity of each of the assist speakers 1112 to 1114 is highly controlled by combination with the sound-absorbing material. The emission sound from the full-frequency range assist speaker 1112 arranged on the dashboard is reflected by a windshield 1130, followed by reaching the vicinity of the face of the driver sitting in the driver's seat 1110. Furthermore, each emission sound emitted from each of the assist speakers 1113 and 1114 arranged in the right door directly reaches the vicinity of the face of the driver. The quality of the three-dimensional audio space formed by the seat speakers 1121L and 111R can be improved over the full-frequency range since the assist speakers 1112 to 1114 including these three channels are provided.

Similarly, as the assist speaker for the occupant sitting in the passenger's seat 1120, a full-frequency range assist speaker 1122 incorporated on the upper surface of the dashboard in the vicinity of the front of the passenger's seat 1120, and a high-frequency range assist speaker 1123 and a mid-frequency range assist speaker 1124, which are incorporated in the inner wall (alternatively, the front pillar) of the door on the driver's seat side are arranged. The directivity of each of the assist speakers 1122 to 1124 is highly controlled by combination with the sound-absorbing material. The emission sound from the full-frequency range assist speaker 1122 arranged on the dashboard is reflected by the windshield 1130, followed by reaching the vicinity of the face of the occupant sitting in the passenger's seat 1120. Furthermore, each emission sound emitted from each of the assist speakers 1123 and 1124 arranged in the left door directly reaches the vicinity of the face of the occupant. The quality of the three-dimensional audio space formed by the seat speakers 1121L and 1121R can be improved over the full-frequency range since the assist speakers 1122 to 1124 including these three channels are provided.

### B-3. Method of Incorporating Assist Speaker

In this Section B-3, a method of incorporating the assist speakers into the vehicle interior will be described.

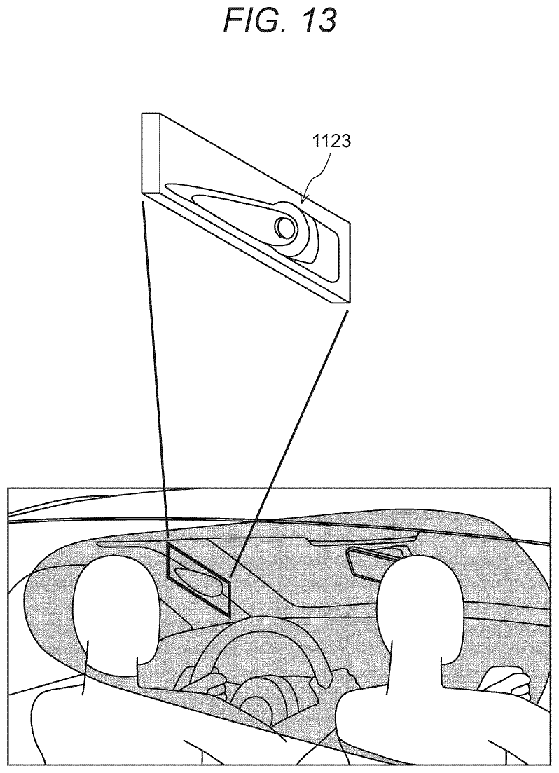

In the in-vehicle three-dimensional acoustic system 1100 illustrated in FIG. 11, the full-frequency range assist speakers 1112 and 1122 for the respective driver's seat 1110 and passenger's seat 1120 are arranged in the vicinity of the center of the dashboard. FIG. 12 illustrates a state in which the full-frequency range assist speakers 1112 and 1122 are incorporated. The emission sound from the full-frequency range assist speaker 1112 is reflected by the windshield 1130, followed by reaching the vicinity of the face of the driver sitting in the driver's seat 1110. Furthermore, the emission sound from the full-frequency range assist speaker 1122 is reflected by the windshield, followed by reaching the vicinity of the face of the occupant sitting in the passenger's seat 1120. Each of the full-frequency range assist speakers 1112 and 1122 is combined with the sound-absorbing material to highly control the directivities such that the emission directions are directed toward the windshield.

FIG. 13 illustrates a state in which the high-frequency range assist speaker 1123 on the passenger's seat 1120 side is incorporated in the left front pillar. Although the high-frequency range assist speaker 1113 on the driver's seat 1110 side is not illustrated, it will be understood that it is substantially symmetrical with the configuration illustrated in FIG. 13. The emission sound from the high-frequency range assist speaker 1123 directly reaches the vicinity of the face of the occupant sitting in the passenger's seat 1120. The high-frequency range assist speaker 1123 is combined with the sound-absorbing material to highly control the directivity such that the emission direction is directed toward the vicinity of the face of the occupant sitting in the passenger's seat 1120.

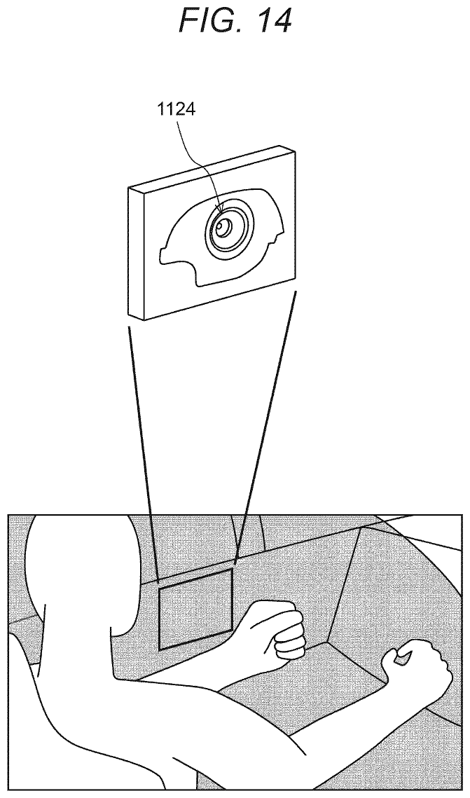

FIG. 14 illustrates a state in which the mid-frequency range assist speaker 1124 on the passenger's seat 1120 side is incorporated in the left front door. Although the mid-frequency range assist speaker 1114 on the driver's seat 1110 side is not illustrated, it will be understood that it is substantially symmetrical with the configuration illustrated in FIG. 14. The emission sound from the mid-frequency range assist speaker 1124 directly reaches the vicinity of the face of the occupant sitting in the passenger's seat 1120. The mid-frequency range assist speaker 1124 is combined with the sound-absorbing material to highly control the directivity such that the emission direction is directed toward the vicinity of the face of the occupant sitting in the passenger's seat 1120.

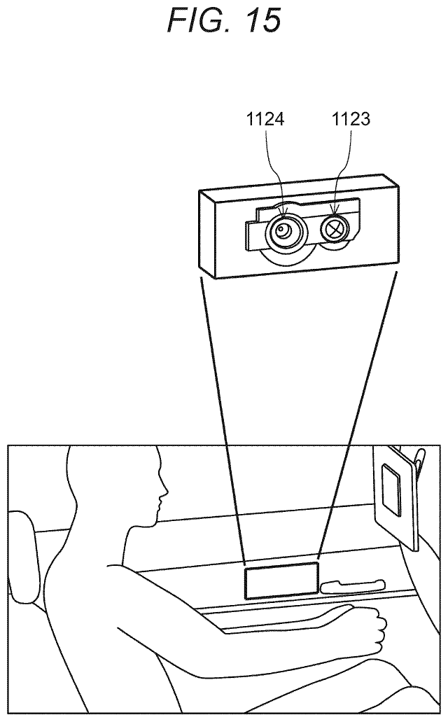

FIG. 15 illustrates a state in which both the high-frequency range assist speaker 1123 and the mid-frequency range assist speaker 1124 on the passenger's seat 1120 side are incorporated in the rear left door. Although the high-frequency range assist speaker 1113 and the mid-frequency range assist speaker 1114 on the driver's seat 1110 side are not illustrated, it will be understood that those are substantially symmetrical with the configuration illustrated in FIG. 15. All the emission sounds from the high-frequency range assist speaker 1123 and the mid-frequency range assist speaker 1124 directly reach the vicinity of the face of an occupant sitting in a rear seat. Each of the high-frequency range assist speaker 1123 and the mid-frequency range assist speaker 1124 is combined with the sound-absorbing material to highly control the directivity such that the emission direction is directed toward the vicinity of the face of the occupant sitting in the passenger's seat 1120.

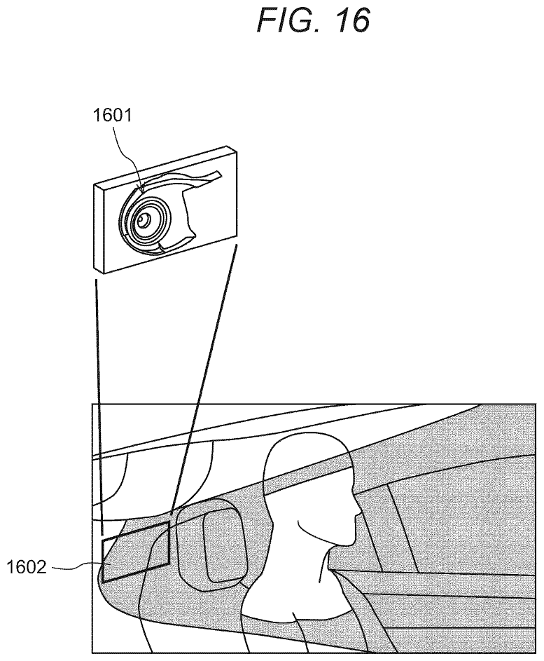

Although a surround speaker is not mentioned in any of Sections B-1 and B-2, sound can be reproduced in a more three-dimensional manner by adding the surround speaker. As an example, FIG. 16 illustrates an example in which a surround speaker 1601 for an occupant on the passenger's seat 1120 side is incorporated in a rear pillar. Although a surround speaker on the driver's seat 1110 side is not illustrated, it will be understood that it is substantially symmetrical with the configuration illustrated in FIG. 16. The emission sound from the surround speaker 1601 directly reaches the vicinity of the face of the occupant sitting in the left rear seat or the occupant sitting in the passenger's seat 1120. The surround speaker 1601 is combined with the sound-absorbing material to highly control the directivity such that the emission direction is directed toward the vicinity of the face of the occupant sitting in the left rear seat or the occupant sitting in the passenger's seat 1120.

### C. Practical Example

### C-1. Application to Monopole

A method of modeling a target sound field as at least one target monopole placed at a defined target position, and approximating a synthesis of the target sound field on the basis of the contributions of a predetermined number of synthesis monopoles placed at the respective synthesis positions (see Patent document 3) has been proposed. According to this method, it is possible to calculate the contributions of a predefined number of composite monopoles, perform modeling on the target sound field as at least one target monopole placed at a target position defined on the basis of a least-squares calculation to minimize errors in the contributions of the predefined number of composite monopoles, generate an output signal based on the target sound field, output a sound corresponding to the output signal from at least one speaker, and approximate the target sound field on the basis of the contributions of the predefined number of synthesis monopoles placed at each synthesis position.

On the other hand, the sound reproducing devices according to the present disclosure are installed at a plurality of positions such as a dashboard, a pillar, and a door, for example, as described in Sections A and B above. Therefore, it is possible to approximate the target sound field at the target position in the vehicle interior by using a plurality of the sound reproducing devices installed in the vehicle interior as the synthesis monopoles in the above method. Since the reflected waves reflected on the glass can be reduced by performing appropriate directional control, it is possible to contribute to improvement of reproducibility of the monopoles.

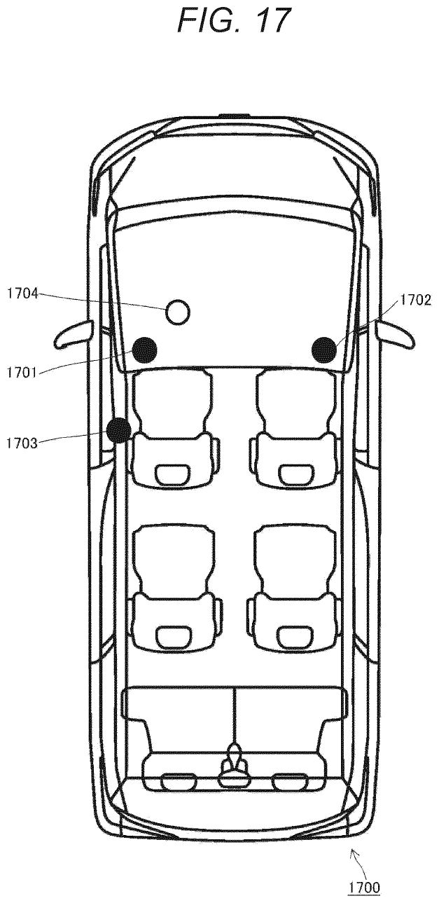

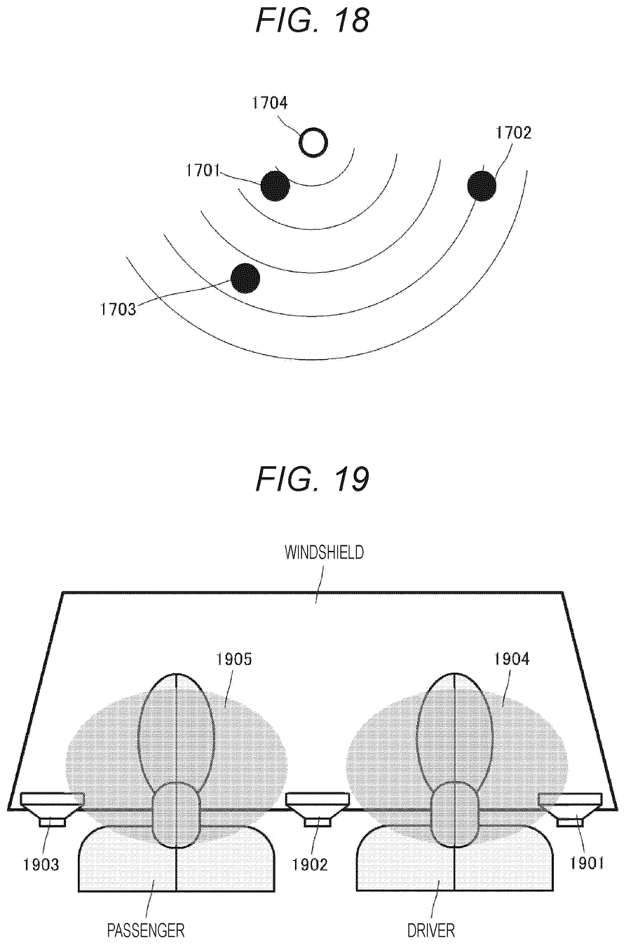

FIG. 17 illustrates a state in which the sound reproducing devices serving as synthesis monopoles are arranged at a total of three positions including two positions 1701 and 1702 on the dashboard of a vehicle 1700 and one position 1703 of the left front door. According to the above method, the gain and delay of a sound to be output from each of sound reproducing devices 1701 to 1703 can be controlled to reproduce a target sound field at the location indicated by reference numeral 1704 different from the locations indicated by reference numerals number 1701 to 1703. FIG. 18 illustrates a state in which the wavefront of the sound output from the target sound field 1704 is approximated by synthesizing the sounds output from the respective sound reproducing devices 1701 to 1703 whose gains and delays are controlled.

### C-2. Application to Sound Zoning

As described in Section A described above, according to the vehicle speaker system with the sound reproducing device according to the present disclosure arranged in the vehicle interior, it is possible to generate an individual sound field for each occupant. Furthermore, sound fields without mixing between adjacent occupants can be obtained by determining the emission direction, and the shape of the sound-absorbing material of each sound reproducing device. Therefore, according to the present disclosure, it is possible to realize individual sound zones for each occupant and reproduce different sounds (music or the like) in a sound field for each occupant, for example.

### C-3. Application to Noise Canceling

Noise canceling is a technique of removing a noise component from sound audible to the ears of a listener by signal processing of superimposing a waveform of noise to be suppressed on an audio signal of a desired sound and reproducing the superimposed noise.

On the other hand, as in Section A described above, in the vehicle speaker system in which the sound reproducing device according to the present disclosure is arranged in the vehicle interior, the left speaker of the right seat and the right speaker of the right seat are slightly separated from each other between the two adjacent seats, so that an emission sound from one speaker becomes noise with respect to an emission sound from the other speaker.

Therefore, for the two speakers arranged at a close distance for different occupants as described above, a sound field without mixing may be generated by performing the noise canceling processing of superimposing a noise canceling signal for canceling the emission sound from the other speaker on the own desired sound signal.

### INDUSTRIAL APPLICABILITY

The present disclosure has been described in detail with reference to the specific embodiments. However, it is obvious that those skilled in the art can make modifications and substitutions of the embodiment without departing from the scope of the present disclosure.

In the present specification, the embodiments in which the sound reproducing device according to the present disclosure is applied to the vehicle speaker system has been mainly described, but the gist of the present disclosure is not limited thereto. The sound reproducing device according to the present disclosure can be applied to speaker systems for various types of mobile devices other than vehicles by utilizing the high directional control performance. Of course, a vehicle exterior sound reproducing device according to the present disclosure can also be applied to an interior other than a moving body.

In short, the present disclosure has been described in an illustrative manner, and the contents disclosed in the present specification should not be interpreted in a limited manner. To determine the subject matter of the present disclosure, the claims should be taken into consideration.

Note that the present disclosure may also have the following configurations.
(1) A sound reproducing device including:
a speaker; and
a sound-absorbing part arranged in front of the speaker and configured to control an emission angle of a sound emitted from the speaker.
(2) The sound reproducing device according to (1), in which
the sound-absorbing part includes a sound-absorbing material and absorbs a sound emitted from the speaker in an unnecessary direction.
(3) The sound reproducing device according to (1) or (2), further including
a reflecting part configured to reflect a sound after passing through the sound-absorbing part to direct the sound in a desired direction.
(4) The sound reproducing device according to (3), in which
the reflecting part includes a reflecting plate with a glass-shape, and
the sound reproducing device forms a sound field that allows the sound from the speaker to be perceived as a sound coming from a virtual speaker arranged outside the reflecting plate.
(4-1) The sound reproducing device according to (4), in which
the virtual speaker is arranged at a higher position than the speaker in real.
(5) An acoustic system including:
a plurality of sound reproducing units provided for each seat in an interior of a mobile device, in which
each sound reproducing unit includes a speaker and a sound-absorbing part that is arranged in front of the speaker and absorbs an emission sound in an unnecessary direction.

(6) The acoustic system according to (5), in which
at least some of the plurality of sound reproducing units are arranged such that emission sounds are reflected by a windshield to be directed to a head section of an occupant sitting in a seat.
(7) The acoustic system according to (5) or (6), in which
the plurality of sound reproducing units provided for each seat includes two left and right sound reproducing units provided for each seat, and the left and right sound reproducing units are arranged such that an emission direction is inclined to be directed toward an occupant sitting in a corresponding seat.
(7-1) The acoustic system according to (7), in which
an arrangement position, an emission direction, and a shape of a sound-absorbing material of each sound reproducing unit are determined so that sounds from the left sound reproducing unit for a sound reproducing unit and the right sound reproducing unit (alternatively, a sound reproducing unit for each seat arranged between adjacent seats) for a left seat are not mixed.
(7-2) The acoustic system according to (7), in which
a position, an angle and an emission range of each speaker are designed on the basis of reflected wave calculations so that emission sounds from left and right speakers installed in each seat are reflected by a three-dimensional curved surface of a windshield and directed toward corresponding occupants, and the shapes of the sound-absorbing material are determined to realize desired directivities of the emission sounds, followed by installation in the vehicle interior.
(8) The acoustic system according to any one of (5) to (7), in which
each of the plurality of sound reproducing unit is used as an assist speaker for a stereo speaker incorporated in a shoulder section or a headrest of a seat.
(9) The acoustic system according to any one of (5) to (8), in which
each of the plurality of sound reproducing units provided for each seat includes at least one of a full-frequency range speaker, a high-frequency range speaker, and a mid-frequency range speaker.
(10) The acoustic system according to any one of (5) to (9), in which
at least some of the plurality of sound reproducing units are incorporated in a dashboard.
(11) The acoustic system according to any one of (5) to (10), in which
at least some of the plurality of sound reproducing units are incorporated in a door or a pillar.
(12) A mobile device including:
a plurality of sound reproducing units provided for each seat in an interior, in which
each sound reproducing unit includes a speaker and a sound-absorbing part that is arranged in front of the speaker and absorbs an emission sound in an unnecessary direction.
(13) The mobile device according to (12), in which
at least some of the plurality of sound reproducing units are arranged such that emission sounds are reflected by a windshield to be directed to a head section of an occupant sitting in a seat.
(14) The mobile device according to (12) or (13), further including
a stereo speaker incorporated in a shoulder section or a headrest of a seat, in which
each of the plurality of sound reproducing unit is used as an assist speaker for the stereo speaker.

### REFERENCE SIGNS LIST

100 Vehicle speaker system
111L, 111L Speaker (for driver)
121L, 121L Speaker (for passenger)
130 Windshield
141L Virtual speaker (for driver)
201 Speaker main body
202 Sound-absorbing material
1000 In-vehicle three-dimensional acoustic system
1010 Driver's seat
1011L, 1011R Seat speaker (for driver's seat)
1012L, 1012R Assist speaker (for driver's seat)
1020 Passenger's seat
1021L, 1021R Seat speaker (for passenger's seat)
1022L, 1022R Assist speaker (for passenger's seat)
1100 In-vehicle three-dimensional acoustic system
1110 Driver's seat
111L, 111R Seat speaker (for driver's seat)
1112 Full-frequency range assist speaker (for driver's seat)
1113 High-frequency range assist speaker (for driver's seat)
1114 Mid-frequency range assist speaker (for driver's seat)
1120 Passenger's seat
1121L, 1121R Seat speaker (for passenger's seat)
1122 Full-frequency range assist speaker (for passenger's seat)
1123 High-frequency range assist speaker (for passenger's seat)
1124 Mid-frequency range assist speaker (for passenger's seat)
1130 Windshield
1601 Surround speaker
1602 Rear pillar

1. A sound reproducing device comprising:
a speaker; and
a sound-absorbing part arranged in front of the speaker and configured to control an emission angle of a sound emitted from the speaker.

2. The sound reproducing device according to claim 1, wherein
the sound-absorbing part includes a sound-absorbing material and absorbs a sound emitted from the speaker in an unnecessary direction.

3. The sound reproducing device according to claim 1, further comprising
a reflecting part configured to reflect a sound after passing through the sound-absorbing part to direct the sound in a desired direction.

4. The sound reproducing device according to claim 3, wherein
the reflecting part includes a reflecting plate with a glass-shape, and
the sound reproducing device forms a sound field that allows the sound from the speaker to be perceived as a sound coming from a virtual speaker arranged outside the reflecting plate.

5. An acoustic system comprising:
a plurality of sound reproducing units provided for each seat in an interior of a mobile device, wherein
each sound reproducing unit includes a speaker and a sound-absorbing part that is arranged in front of the speaker and absorbs an emission sound in an unnecessary direction.

6. The acoustic system according to claim 5, wherein
at least some of the plurality of sound reproducing units are arranged such that emission sounds are reflected by a windshield to be directed to a head section of an occupant sitting in a seat.

7. The acoustic system according to claim 5, wherein
the plurality of sound reproducing units provided for each seat includes two left and right sound reproducing units provided for each seat, and the left and right sound reproducing units are arranged such that an emission direction is inclined to be directed toward an occupant sitting in a corresponding seat.

8. The acoustic system according to claim 5, wherein
each of the plurality of sound reproducing units is used as an assist speaker for a stereo speaker incorporated in a shoulder section or a headrest of a seat.

9. The acoustic system according to claim 5, wherein
each of the plurality of sound reproducing units provided for each seat includes at least one of a full-frequency range speaker, a high-frequency range speaker, and a mid-frequency range speaker.

10. The acoustic system according to claim 5, wherein
at least some of the plurality of sound reproducing units are incorporated in a dashboard.

11. The acoustic system according to claim 5, wherein
at least some of the plurality of sound reproducing units are incorporated in a door or a pillar.

12. A mobile device comprising:
a plurality of sound reproducing units provided for each seat in an interior, wherein
each sound reproducing unit includes a speaker and a sound-absorbing part that is arranged in front of the speaker and absorbs an emission sound in an unnecessary direction.

13. The mobile device according to claim 12, wherein
at least some of the plurality of sound reproducing units are arranged such that emission sounds are reflected by a windshield to be directed to a head section of an occupant sitting in a seat.

14. The mobile device according to claim 12, further comprising
a stereo speaker incorporated in a shoulder section or a headrest of a seat, wherein
each of the plurality of sound reproducing units is used as an assist speaker for the stereo speaker.
